(19) United States
(12) Patent Application Publication
(10) Pub. No.: US 2003/0123357 A1
(43) Pub. Date: Jul. 3, 2003

(54) Apparatus comprising an apparatus for writing data on a recording medium and method implemented in such an apparatus

(76) Inventors: Marinus Adrianus Henricus Looijkens, Eindhoven (NL); James Joseph Anthony McCormack, Eindhoven (NL)

Correspondence Address: PHILIPS ELECTRONICS NORTH AMERICAN CORP, 580 WHITE PLAINS RD, TARRYTOWN, NY, 10591, US

(21) Appl. No.: 10/313,715

(22) Filed: Dec. 6, 2002

(30) Foreign Application Priority Data
Dec. 11, 2001 (FR) 0115978

(51) Int. Cl. G11B 7/00

(52) U.S. Cl. 369/53.2; 369/53.37; 369/59.11

(57) ABSTRACT

This apparatus (1) notably comprises a writing device (3) for writing data available at a terminal (5). As optical discs have write characteristics, the write pulses representing the data to be stored have different forms. Thus these various pulses are put in a read/write memory (30) fed via a database (35). Writing on an optical disc.

The invention relates to an apparatus in the form of a data recording device for writing data on a recording medium, notably an optical disc, the apparatus comprising a write signal generator which has certain characteristics relating to said recording medium.

The invention also relates to a method implemented in such an apparatus.

Such an apparatus is described in U.S. Pat. No. 6,285,647 filed in the name of the applicants. In this document there is proposed to generate well-defined pulse sequences for effecting the recordings. However, this known apparatus does not propose to change these defined pulses as a function of the type of recording medium.

The present invention proposes an apparatus of the type defined in the opening paragraph of which it is an object to improve the prior-art apparatus to provide it with a large ability to be adapted to various recording media.

For this purpose, such an apparatus is characterized in that the characteristic features of these write signals are contained in a first read/write memory for which an address code generator is provided.

An important characteristic feature of the invention according to which the memory element is of the read/write type (RAM memory) permits to be adapted to the recording of all the media.

A method implemented in such an apparatus is characterized in that it comprises the following steps of:

storing write pulse definitions in a memory element,

determining the type of recording medium,

obtaining the pulse definition as a function of the type of the detected recording medium,

writing data on the medium according to said detected definition.

These and other aspects of the invention are apparent from and will be elucidated, by way of non-limitative example, with reference to the embodiment(s) described hereinafter.

### IN THE DRAWINGS

FIG. 1 shows a diagram of the apparatus according to the invention,

FIG. 2 shows the shape of write signals for various media,

FIG. 3 shows the clock signals Hrlc in correlation with a symbol,

FIG. 4 is a diagram to explain the storage of a write signal,

FIG. 5 shows a first diagram of a decoder,

FIG. 6 shows another diagram of a decoder,

FIG. 7 shows a first part of an address decoding table used in said decoder, and

FIG. 8 shows a second part of the decoding table.

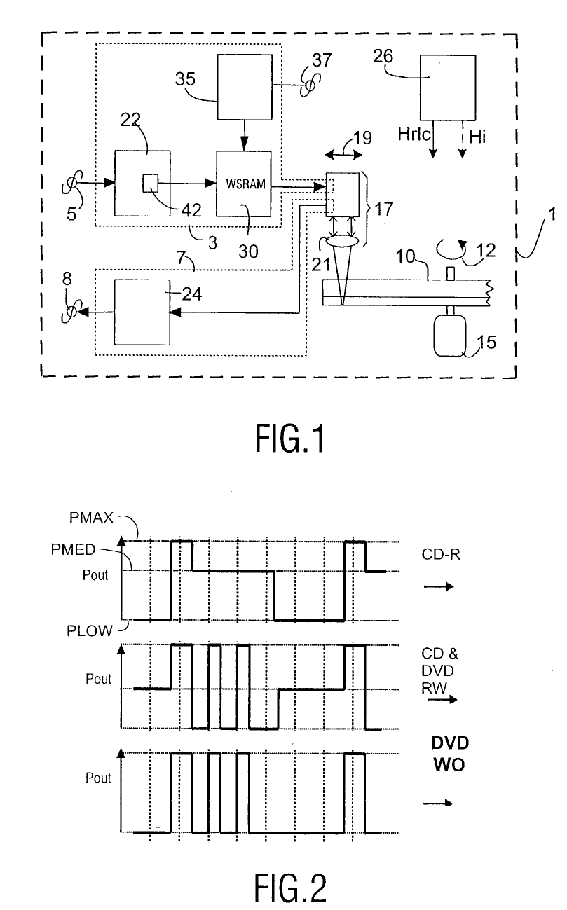

In FIG. 1 is shown an apparatus 1 comprising a recording device 3 according to the invention for writing data applied to the terminal 5 and, possibly, a data reconstruction device 7 for reconstructing data on a terminal 8. The reference 10 indicates the disc which in this example constitutes the recording medium. It is on this disc that data are proposed to be recorded and it is based on this that it will be possible to obtain data for reconstructing them at the terminal 8. This disc turns in a direction indicated by the arrow 12, caused by a motor 15. A read/write head 17 moving in a radial direction relative to the disc 10 permits to explore the whole disc. This is represented by the arrow 19. This head comprises at least a laser diode system for writing and/or reading. The reading and/or writing beam is focused on a layer of the disc 10 by means of an objective 21.

FIG. 2 shows the shape of the power “Pout” of the laser beam, which is to radiate the disc to record a binary element. This power has variable intensities as a function of the medium on which a recording is made. In this FIG. 2, several cases are shown: that of etching pulses for a CD-R which is an optical disc that can be read once when it has been recorded. Another case is that of CD-W and DVD rewritable discs. And, finally, the write-once DVD disc. These etching pulses may have three levels PMAX, PMED and PLOW. The data to be recorded is first of all processed by an etching interface circuit 22 to which the terminal 5 is connected. Similarly, an output interface circuit 24 receives the data from the laser head 17 so as to reconstruct them on the terminal 8 in the form suitable to the user. A clock 26 sets the various timings Hi, . . . , Hrlc necessary for the operation of the apparatus.

For an adaptation to these various pulse configurations, the invention proposes to record various parameters in a memory 30 which parameters define these write pulses. The memory 30 contains these configurations only for the recording medium which is located inside the apparatus. The various configurations which are possible are contained in a database situated in a memory 35. This database may even be located outside the apparatus. The choice of the configuration to be recorded in the memory 30 is determined by selection data applied to a terminal 37.

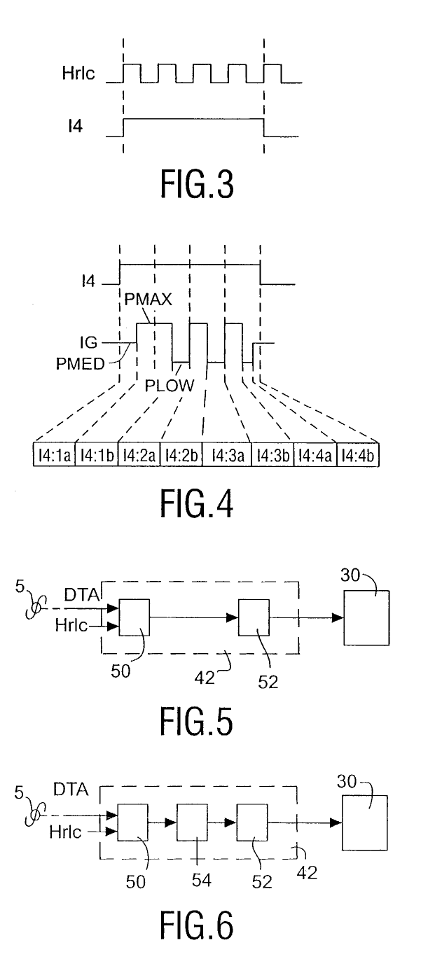

FIG. 3 and the following Figures show how the etching pulses are written in the various memories 30 and 35 and notably in the memory 30. The data are coded by means of an RLC code (known by the name of Runlength Limited code). These codes have different lengths which is detected at the level of the interface circuit 22. These lengths run from 1 to 15 clock periods Hrlc. These symbols thus carry the names I1 to I15. In FIG. 3 the symbol I4 has a duration equal to four periods of the clock signal. Depending on the type of disc to be made, an etching pulse IG shown in FIG. 4 is made to correspond to this symbol. The levels of this pulse have levels PMAX, PMED and PLOW as this has already been observed. These levels have variable durations. To be able to store this etching pulse, a binary word is allocated for defining the amplitude of the pulse and for defining the duration. This is represented by I4: 1a I4: 1b I4: 2a I4: 2b I4:3a . . . I4: 4b in FIG. 4. For determining the symbols, a qualified decoder of the RLC code is used which is referred to as 42 in FIG. 1 and forms part of the recording device 3. Based on this decoder 42 the addresses for the memory 30 are produced.

This manner of coding gives the number of entries Nb necessary for the memory 30.

$$Nb = {\sum }_{i = 1}^{N} i = \frac{N ( N + 1 )}{2}$$

To store the symbols I1 to I15, Nb=120 is obtained.

However, the etching pulse forms also depend on preceding etching pulses.

FIG. 5 shows an embodiment for a first RLC decoder. This decoder takes preceding pulses into account. It comprises a symbol length detector 50 and an address code generator 52. According to this example for a given medium, the memory 30 is to have an addressing which corresponds to 3600 addresses for words of “n” binary elements. This addressing may be calculated in the following manner. Starting from Nb=120, 15 space pulses or 120 mark pulses can be assigned to each of these locations. The space pulses and mark pulses correspond, respectively, to the binary “0” and “1” values. They are also called land and pit.

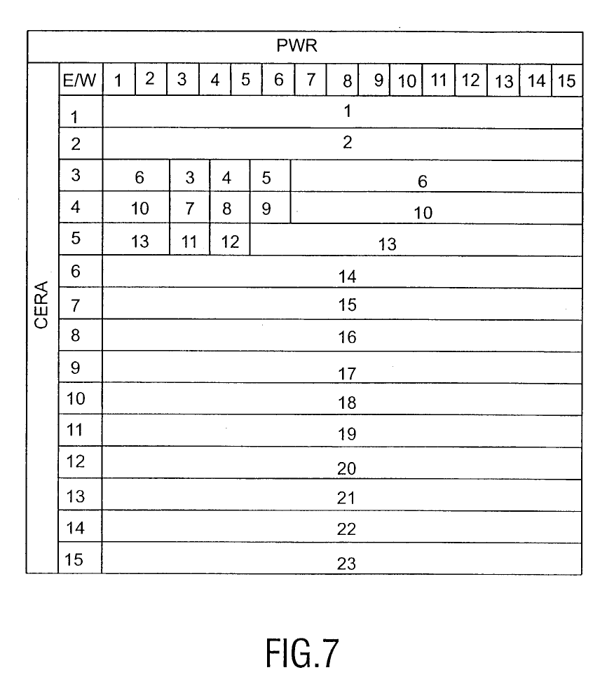

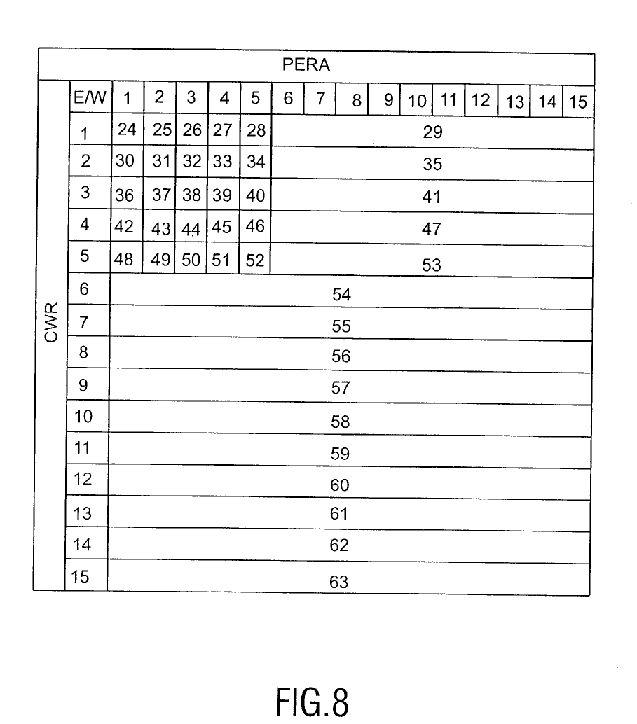

FIG. 6 shows a second example of embodiment of an RLC decoder. The elements which are in common with those of the preceding Figures have like references. This second example comprises a decoding table 54 arranged between the symbol length detector 50 and the address code generator 52. This second example is based on the hypothesis that all combinations do not require being stored in the memory 30. As a matter of fact, there are 450 possible combinations for all the possibilities of former pulse/current pulse, that is to say, that 225 (15×15) possibilities are considered between a space pulse and a mark pulse. It should be underlined that a mark pulse is always followed by a space pulse and vice versa. This number of 450 may be reduced in practice to 246. The FIGS. 7 and 8 show how the decoding table 54 can be organized. The FIG. 7 shows a part P1 of the table relating to a erase pulse following a write pulse, whereas FIG. 8 shows the other part of the table P2 relating to the write pulses following a erase pulse. Thus this table transforms the 450 possible combinations into 63 output values. The address converter 52 is to produce the addresses for the memory 30. The addresses to be generated by the address code generator 52 are established from these tables. As regards the part of the table P1, the number of entries Nb1 for the table 30 is given by:

$$Nb1 = \frac{N ( N + 1 )}{2} + ( E3 .3 ) + ( E4 .4 ) + ( E5 .2 )$$

which gives with E3=3, E4=4 and E5=5:

Nb1=151.

As regards the part P2, the number of entries Nb2 becomes:

$$Nb2 = \frac{N ( N + 1 )}{2} + 5 {\sum }_{i = 1}^{M} i$$

which gives with N=15 and M=5.

Nb2=195

from which the total number Nb of entries to be provided in the memory 30 is:

Nb=246.

Generating addresses for the memory 20 is not direct, therefore and in an advantageous manner, the address code generator 52 is realized by means of a RAM memory. This permits a simple implementation and, on the other hand, the possibility of defining strategies that require a limited number of entries of this table. This generator realized by means of a RAM memory contains pointers for the memory 30. Thus, a certain flexibility is obtained for the data written in the memory 30.

For example, a minimum strategy can be defined which does not take preceding RLC symbols into account. In the scope of the described example, 120 locations are sufficient to which is added one location for the delete pulse.

Another strategy may be an uncompromising strategy. Thus all the elements of the decoding tables DLC may use an entry in the memory 30. This thus requires 246 memory entries.

According to another embodiment, it is possible to no longer use the decoding table 54. A decoding element 52 is thus produced based on a read/write memory (RAM memory). If all the possible combinations of the symbols I1 to I15 are respected, a memory is needed which produces 450 addresses: −225 for the write pulses following the erase pulses and 225 for the erase pulses following the write pulses. These numbers are given within the scope of the described example.

1. An apparatus in the form of a data writing device for writing data on a recording medium, notably an optical disc, the apparatus comprising a write signal generator which has certain characteristics relating to said recording medium, characterized in that the characteristic features of these write signals are contained in a first read/write memory for which an address code generator is provided.

2. An apparatus as claimed in claim 1, characterized in that a database is provided on the basis of which said first read/write memory is loaded with a view to be adapted to said recording medium.

3. An apparatus as claimed in claim 1 or 2, characterized in that said address code generator takes into account the preceding write signal so as to address the first read/write memory with a view to producing the current write pulse.

4. An apparatus as claimed in one of the claims 1 to 3, characterized in that said generator comprises a second read/write memory for containing an addressing table.

5. An apparatus as claimed in one of the claims 1 to 4, characterized in that it further includes a reading device for reading said recording medium.

6. A recording method implemented in an apparatus as claimed in one of the claims 1 to 5, characterized in that it comprises the following steps of:
storing write pulse definitions in a memory element,
determining the type of recording medium,
obtaining the pulse definition as a function of the type of the detected recording medium,
writing data on the medium according to said detected definition.
